(19) United States
(12) Patent Application Publication
(10) Pub. No.: US 2009/0147252 A1
(43) Pub. Date: Jun. 11, 2009

(54) FLUORESCENCE OBSERVATION OR FLUORESCENCE METERING-SYSTEM AND FLUORESCENCE OBSERVATION OR FLUORESCENCE METERING-METHOD

(75) Inventors: Atsushi Goto, Oume-shi (JP); Hiroaki Kinoshita, Akishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORTION, Tokyo (JP)

(21) Appl. No.: 12/330,623

(22) Filed: Dec. 9, 2008

(30) Foreign Application Priority Data
Dec. 11, 2007 (JP) 2007-319943

(51) Int. Cl. G01N 21/01; G01N 21/64

(52) U.S. Cl. 356/244

(57) ABSTRACT

A fluorescence observation or fluorescence metering-system includes a low-fluorescence specimen holding member used therein. The low-fluorescence specimen holding member satisfies a condition, BSG′/BSG≦0.6, where BSG′ is an average intensity value of auto-fluorescence from the low-fluorescence specimen holding member and BSG is an average intensity value of auto-fluorescence from a conventional specimen holding member generally used.

This application claims benefits of Japanese Patent Application No, 2007-31994.3 filed in Japan on Dec. 11, 2007, the contents of which are incorporated herein by reference.

### BACKGROUND OF THE INVENTION

1. Field of the Invention

This invention relates to a fluorescence observation or fluorescence metering-system and a fluorescence observation or fluorescence metering-method.

2. Description of Related Art

By the developments in recent years of measuring instruments and apparatuses in the fields of microscopes, fluorescence microscopes, and protein and/or DNA analytical apparatuses, tendencies of observations and/or measurements in these fields are changed. In the changes of the tendencies, there are two great currents described below.

One of them is a change of observation and measurement objects extending from the observations and/or measurements of fixed cells to those of living cells. The advent of the post-genomic era has increased the importance of the technique that allows accurate observation and/or measurement of feeble fluorescent light in a broad band with respect to the fluorescence measurement of a single-molecule fluorescent dye and a simultaneous analysis of functions of living bodies by the color diversification of a fluorescent dye. In the most advanced research field, the need that observations of cells, in vivo, should be continued for a long period of time (in the range from several days to a few weeks) has been increased for purposes of the functional clarification of living bodies and the behavior analysis and/or interaction analysis of proteins, and various techniques for carrying out such observations have been proposed. In the observation of the cell, the technique of expressing a fluorescent protein in a desired cell or introducing the fluorescent dye to observe its fluorescent light constitutes the main current. In addition, there is a single-molecule fluorescence observation that is thought of as an ultimate feeble-fluorescence observation, and feebler-fluorescence observation and/or measurement is needed. In the fluorescence observation, however, when the intensity of light for exciting a fluorescent substance (excitation light) is too high, damage is caused to the cell. Hence, in order to keep the cell alive for a long period of time, it is necessary to set as low an intensity of the excitation light as possible. On the other hand, it is well known that when the excitation light continues to irradiate the fluorescent substance, the fluorescent light is gradually bleached. It is thus extremely useful to enable the feeble fluorescent light to be observed at a high S/N ratio while suppressing bleaching by irradiating the substance with feeble excitation light. However, when the excitation light is made faint, the intensity of the fluorescent light is lowered accordingly and thus it becomes difficult to obtain a fluorescent image with a high S/N ratio. Specifically, as the fluorescent light becomes feeble, the influence of a noise is increased and the S/N ratio is reduced. Here, it is assumed that the noise includes auto-fluorescence mainly emanating from an optical system or a specimen.

The other current is a change from an apparatus provided with only the function of observation like a conventional microscope apparatus to an apparatus provided with the function of measuring and quantifying the intensity of fluorescent light, the wavelength, and the localization of matter to be detected. In this case, accurate quantification including the noise is required.

Conventional fluorescence observation apparatuses and fluorescence measurement apparatuses are proposed, for example, in Japanese Patent Kokai No. Hei 08-320437 and Hei 08-178849.

The present inventors have invented a fluorescence observation or fluorescence metering-system and a fluorescence observation or fluorescence metering-method, set forth in Japanese Patent Application Nos. 2006-175495 and 2006-175496, in order to meet the problem of the noise caused by the auto-fluorescence.

### SUMMARY OF THE INVENTION

The fluorescence observation or fluorescence metering-system according to the present invention comprises a low-fluorescence specimen holding member used therein. The low-fluorescence specimen holding member satisfies the following condition:

BSG′/BSG≦0.6 (1-1)

where BSG′ is an average intensity value of auto-fluorescence from the low-fluorescence specimen holding member and BSG is an average intensity value of auto-fluorescence from a conventional specimen holding member generally used.

The fluorescence observation or fluorescence metering-method according to the pre-sent invention comprises the steps of (A) selecting a specimen emitting fluorescent light that uses a living cell, (B) selecting an application for observing or measuring the specimen selected in step (A) and the fluorescence observation or fluorescence metering-system comprising a low-fluorescence specimen holding member that satisfies the following condition, and (C) making the fluorescence observation or fluorescence measurement of the specimen selected in step (A) by using the application and the system selected in step (B):

BSG′/BSG≦0.6 (1-1)

where BSG′ is an average intensity value of auto-fluorescence from the low-fluorescence specimen holding member and BSG is an average intensity value of auto-fluorescence from a conventional specimen holding member generally used.

In the fluorescence observation or fluorescence metering-method of the present invention, it is desirable that the specimen emitting the fluorescent light that uses the living cell, selected in step (A), satisfies at least one of the following conditions:

(S−s)/(B+b)≦5 (2-1)

4BSG/B≧0.2 (3-1)

where S is an average intensity value of the fluorescent light emitted from the specimen, is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.

In the fluorescence observation or fluorescence metering-method of the present invention, it is desirable that the application selected in step (B) is FRET (Fluorescence Resonance Energy Transfer).

In the fluorescence observation or fluorescence metering-method of the present invention, it is desirable that the application selected in step (B) is calcium ion imaging.

In the fluorescence observation or fluorescence metering-method of the present invention, it is desirable that the application selected in step (B) is a moving-picture observation or time-lapse observation.

In the fluorescence observation or fluorescence metering-method of the present invention, it is desirable that the system selected in step (B) is a fluorescence microscope system.

In the total reflection illumination fluorescence observation or fluorescence metering-system according to the present invention, a condenser lens is used to provide illumination so that laser light is totally reflected at the bottom of a low-fluorescence specimen holding member and fluorescent light emitted from a specimen held through the specimen holding member by total reflection illumination is detected through an objective lens provided opposite to the condenser lens. The low-fluorescence specimen holding member satisfies the following condition:

BSG′/BSG≦0.89 (1-1′)

where BSG′ is an average intensity value of auto-fluorescence from the low-fluorescence specimen holding member and BSG is an average intensity value of auto-fluorescence from a conventional specimen holding member generally used.

In the fluorescence observation or fluorescence metering-system of the present invention, it is desirable that the low-fluorescence specimen holding member is a glass petri dish or glass-bottomed dish.

In the fluorescence observation or fluorescence metering-system of the present invention, it is desirable that the low-fluorescence specimen holding member is a slide glass.

According to the present invention, the fluorescence observation system, fluorescence metering-system, fluorescence observation method, and fluorescence metering-method are obtained in which the influence of the noise caused by the auto-fluorescence can be lessened, a high-precision and high-quality fluorescence observation and fluorescence measurement are possible, and the observation and measurement of feeble fluorescent light are also possible. More specifically, the fluorescence observation system, fluorescence metering-system, fluorescence observation method, and fluorescence metering-method are obtained in which the specimen holding member is used to enable a high-precision and high-quality fluorescence observation and fluorescence measurement and the observation and measurement of feeble fluorescent light.

These and other features and advantages of the present invention will become apparent from the following detailed description of the preferred embodiments when taken in conjunction with the accompanying drawings.

### BRIEF DESCRIPTION OF THE DRAWINGS

FIG. 1 is a side view showing a schematic structure of a reflecting fluorescence microscope apparatus using a white arc light source, as an example of an inverted fluorescence microscope apparatus which is applicable to the fluorescence observation or fluorescence metering-system, according to Embodiment 1 and Comparative example 1 of the present invention.

FIG. 2 is an explanatory view showing a simplified optical arrangement of essential parts in the reflecting fluorescence microscope apparatus of FIG. 1.

FIG. 3 is a side view showing a schematic structure of a transmitting fluorescence microscope apparatus using a white arc light source, as another example of an inverted fluorescence microscope apparatus which is applicable to the fluorescence observation or fluorescence metering-system according to Embodiment 1 and Comparative example 1 of the present invention.

FIG. 4 is an explanatory view showing a simplified optical arrangement of essential parts in the transmitting fluorescence microscope apparatus of FIG. 3.

FIG. 5 is a side view showing a schematic structure of a total, reflection fluorescence microscope apparatus of a condenser lens mode using a laser light source, as an example of an upright fluorescence microscope apparatus which is applicable to the fluorescence observation or fluorescence metering-system according to Embodiment 2 and Comparative example 2 of the present invention.

FIG. 6 is an explanatory view showing a simplified optical arrangement of essential parts in the total reflection fluorescence microscope apparatus of FIG. 5.

### DETAILED DESCRIPTION OF THE PREFERRED EMBODIMENTS

Before undertaking the description of the embodiments, the process through which the present invention has been considered will be explained.

### Ranking of S/N Ratio of Fluorescent Image Devoting Attention to Brightness of Specimen

The present inventors have first tried that noise levels required for the fluorescence observation apparatus and the fluorescence metering apparatus in which the applications (microscopy systems) of a high-precision and high-quality fluorescence observation and/or fluorescence measurement and a feeble-fluorescence observation and feeble-fluorescence measurement are possible are ranked as described later in accordance with the specimen used for the observation and/or measurement. Here, a formula used for ranking is defined. When an average intensity value of fluorescent light from an object to be observed (or an object to be measured) is represented by S, an average intensity value of auto-fluorescence of the background (a portion where the object to be observed or the object to be measured is absent in an observation region) is represented by B, and the fluctuations of these intensities are represented by s and b, respectively, the S/N ratio of the application is defined by the following formula:

(S−s)/(B+b) (2-0)

### (1) Single-Molecule Fluorescence Observation

As a specimen most susceptible to the influence of auto-fluorescence, consideration has been given to the S/N ratio of a so-called single-molecule fluorescence observation. In the single-molecule fluorescence observation, auto-fluorescence from an observation or measurement optical system is a main noise component. In the single-molecule fluorescence observation, the S/N ratio satisfies the following condition:

(S−s)/(B+b)≦2 (2-3)

### (2) Fluorescence Observation of Dark Specimen

Subsequently, consideration has been given to the fluorescence observation (or measurement) using the living cell. In the observation of the living cell, it is necessary to maintain the activity of the cell for a long period of time. In order to lessen damage to the cell, it is common practice to reduce the amount of fluorescent substance or to lower the intensity of excitation light with which the living cell is irradiated. Hence, the intensity of fluorescent light takes a downward tendency. In the fluorescence observation of the dark specimen, the S/N ratio satisfies the following condition:

(S−s)/(B+b)≦3 (2-2)

(3) Fluorescence Observation of Specimen with Common Brightness

Finally, consideration has been given to the case where the intensity of fluorescent light is high in the fluorescence observation (or measurement) using a general fixed cell or a living cell. In the fixed cell, there is no need to maintain the activity of the cell, and thus it is possible to increase the concentration of the fluorescent substance and to heighten the intensity of the excitation light. Consequently, the intensity of fluorescent light can be increased. Even when the living cell is used, the same holds for the case where the maintenance of the activity requires a shirt period of time or where fluorescent protein is expressed in a part that has little influence on the cell. In this case, the S/N ratio satisfies the following condition:

(S−s)/(B+b)≦5 (2-1)

As mentioned above, the present inventors have divided the brightness of specimens used for the fluorescence observation (or measurement) into three classes in accordance with the S/N ratio of the application.

### Kind of Application

Next, the present inventors have considered the kind of application for making the fluorescence observation (or measurement) of the specimens.

### (1) FRET Observation

To observe or measure the fluorescent specimen, there is FRET (Fluorescence Resonance Energy Transfer) as one of techniques often used.

For the FRET, two fluorescent substances, a donor and an acceptor, are used so that the fluorescent wavelength of the donor substance practically coincides with the excitation wavelength of the acceptor substance. Thus, the wavelength of excitation light in the FRET is located on the short-wavelength side, compared with the wavelength of excitation light where the acceptor substance is used by itself. On the other hand, the auto-fluorescence from the observation or measurement optical system tends to strengthen as the wavelength of the excitation light becomes short. Hence, the FRET has the problem that even when the same fluorescent wavelength is observed or measured, the production of the auto-fluorescence from the observation or measurement optical system becomes pronounced.

### (2) Calcium Ion Imaging

There is a calcium ion as a substance that plays a major role in the transmission of an intracellular or intercellular signal. It is supremely important for functional clarification of the cell to observe and measure the gradient and change of the concentration of the calcium ion. As reagents often used when the concentration of the calcium ion is detected, there are Fura-2 and Indo-1. For these reagents. UV light of wavelength 300-400 nm is utilized as the excitation light. Consequently, the problem arises that the production of the auto-fluorescence from the observation or measurement optical system becomes pronounced. Although the fluorescent reagent called Cameleon that does not use the UV light has recently been provided. Cameleon is the reagent applying the FRET mentioned above and hence encounters the same problem as in the FRET.

### (3) Moving-Picture and Time-Lapse Observations

In the observation of a single molecule on a cell film or in the FRET and calcium ion imaging, it is important to study not only the intensity ratio, but also a time change of the intensity ratio. When the speed of the change is high, a moving-picture observation by a video rate or higher-speed camera is carried out. In the moving-picture observation, since the phenomenon of a quick change is detected, the exposure time of the camera per frame is necessarily reduced and a luminance level of fluorescent light is impaired, in the moving-picture observation, therefore, the fluorescent light is feebler than in a common fluorescence observation or measurement, and thus it is difficult to obtain image data with favorable S/N ratios.

On the other hand, when the speed of the change is low, a time-lapse observation in which an intermittent observation is continued in the range from several hours to a few days is carried out. In the time-lapse observation, since the activity of the cell must be maintained for a long period of time, it is needed that the intensity of the excitation light with which the cell of the specimen is irradiated is kept to a minimum. In the time-lapse observation, therefore, the fluorescent light is feebler than in a common fluorescence observation or measurement, and thus it is difficult to obtain image data with favorable S/N ratios.

As mentioned above, even in various applications that fluorescent specimens are observed, there is a factor that degrades the S/N ratio according to each application. Actually, by a combination of the specimen applying to the condition, of brightness of at least one of Conditions (2-1)-(2-3) with the application of each of Items (1)-(3), the fluorescence observation or measurement is carried out, and the S/N ratio is also governed by combinations of Conditions (2-1)-(2-3) with Applications (1)-(3).

### Study of Proportion of Auto-Fluorescence

Subsequently, the present inventors have studied the proportion of auto-fluorescence from each of optical systems, such as microscopes and measurement apparatuses, using conventional common objective lenses, immersion substances, and specimen holding members. Also, the specimen holding member in the present invention refers to an optical member which is provided to hold a fluorescence observation specimen on a microscope stage and does not affect imaging performance, but affects a fluorescence observation image due to auto-fluorescence produced therein. Specifically, this member includes a slide glass or a glass petri dish or glass-bottomed dish shown in Embodiment 2 described later, and is not limited to the slide glass alone.

Noises in the fluorescence microscope system are roughly divided into two types: auto-fluorescence from the specimen and auto-fluorescence from the optical system. In the case where an upright microscope. BX51 (made by OLYMPUS CORP.) is used for measurement, the present inventors have studied the proportion of the auto-fluorescence from the specimen to the auto-fluorescence from the optical system in the noise components. Light emitted from a light source, after being selected as a proper wavelength according to an observation subject by a filter (a filter unit, for example. U-MWIB3 (made by OLYMPUS CORP.)), passes through an illumination optical system and irradiates a specimen as excitation light. In this case, the objective lens, the immersion substance, and the specimen holding member, arranged in the illumination optical system, and substances enclosed together with the specimen are excited to produce auto-fluorescence responsible for the noise. The present inventors have measured the amount of auto-fluorescence by using a detector such as a photomultiplier tube (by Hamamatsu Photonics K. K.) mounted to an observation optical system or Model CoolSNAP HQ (by Photometries Inc.) that is a cooled CCD.

First, auto-fluorescence from the background of the specimen is measured by a common reflection fluorescence observation method. The same measurement is then made in a state where the specimen is eliminated. The difference between values of these measurements indicates the auto-fluorescence from the specimen and a remaining value is calculated as the auto-fluorescence from the optical system. It has been found that, of noises thus calculated, the auto-fluorescence from the specimen fluctuates greatly, for example, in accordance with a cleaning way of the specimen or the condition of preparation of the specimen as described later. As a result, the present inventors have found that the tendencies of the degree of the influence of the auto-fluorescence from the specimen on the entire noise are roughly divided into three classes in accordance with the condition of preparation of the specimen. By using the proportion of the noise of the auto-fluorescence from the optical system to the entire noise, these can be shown as follows:

Common Specimen (not Cleaned):

(Noise of auto-fluorescence from the optical system)/B≧0.2 (3′-1)

Cleaned Specimen:

(Noise of auto-fluorescence from the optical system)/B≧0.4 (3′-2)

Thoroughly Cleaned Specimen:

(Noise of auto-fluorescence from the optical system)/B≧0.6 (3′-3)

where, in Conditions (3′-1)-(3′-3), B is an average intensity value of auto-fluorescence of the background (a portion where the object to be observed or the object to be measured is absent in an observation region).

In each of Conditions (3′-1)-(3′-3), as the lower limit value is increased, the proportion of the noise of the auto-fluorescence from the optical system becomes high, and when the auto-fluorescence from the optical system is improved, its effect becomes more marked. In order to improve the S/N ratio, it is necessary to know the breakdown of the noise of the auto-fluorescence from the optical system. The present inventors have thus studied the proportion of a noise (auto-fluorescence) value of each of the objective lens, the immersion substance, and the specimen holding member. For the measurement, the same method as in the case where the proportion of the auto-fluorescence from the specimen to the auto-fluorescence from the optical system, mentioned above, has been studied is used.

First, the amount of auto-fluorescence detected in a state (an actual working state) where the objective lens, the immersion substance, the cover glass, and the specimen holding member are properly arranged in the illumination optical system is measured. After that, the amount of auto-fluorescence is measured in a state where the cover glass is removed from the optical system, then in a state where the immersion oil is removed from the optical system, and further in a state where the specimen holding member is removed from the optical system. The difference between these values is taken to thereby find the value of auto-fluorescence from each of the objective lens, the immersion oil, the cover glass, and the specimen holding member.

The measurement of the value of auto-fluorescence from each of the objective lens. UPLSAPO 60XO, (by OLYMPUS CORP.), the immersion oil (by OLYMPUS CORP.), the cover glass (by MATSUNAMI GLASS IND., LTD.), and a slide glass (by MATSUNAMI GLASS IND., LTD.) commonly used as an example of the specimen holding member shows that the values of auto-fluorescence from the objective lens, the immersion oil, the cover glass, and the slide glass are almost the same. Further, when auto-fluorescence in a state where the objective lens is removed from the optical system is measured and the difference with the measured value of auto-fluorescence in a state where the objective lens is placed in the optical system is taken to thereby find the value of auto-fluorescence of each of the other optical members, this value is approximately 10% of the amount of auto-fluorescence detected in a state (an actual working state) where the objective lens, the immersion substance, the cover glass, and the specimen holding member are properly arranged in the illumination optical system.

Consequently, it is estimated that, of auto-fluorescence constituting the noise of the entire observation optical system (or the entire measurement optical system), the objective lens accounts for about 20-25%; the immersion substance for about 20-25%; the cover glass for about 20-25%; the specimen holding member for 20-25%; the objective lens, the immersion substance, the cover glass, and the specimen holding member for about 90% in total; and the other for a little less than about 10%. In the feeble-fluorescence observation (or measurement), therefore, the auto-fluorescence from the objective lens, the immersion substance, the cover glass, and the specimen holding member causes the reduction of the S/N ratio and the detection performance of the entire system can be improved. However, the present inventors have ascertained that, in order to improve the S/N ratio by 5%, it is necessary to reduce at least one of four auto-fluorescence components of the objective lens, the immersion substance, the cover glass, and the specimen holding member by 40% or the four auto-fluorescence components by 10% in total.

Also, in the total reflection illumination fluorescence observation or fluorescence metering-system in which a condenser lens is used to provide illumination so that laser light is totally reflected at the bottom of a low-fluorescence specimen holding member and in which fluorescent light emitted from a specimen held through the specimen holding member by total reflection illumination is detected through an objective lens provided opposite to the condenser lens, illumination light is incident on the specimen holding member without passing through the objective lens and the cover glass. When the light is totally reflected at an interface between the specimen holding member and the specimen, the specimen is excited by an evanescent wave slightly penetrating into the specimen. In a total reflection microscope observation using such a condenser lens, therefore, fluorescent light emitted fairly close to the specimen is only captured and the auto-fluorescence constituting the noise of each of the objective lens, the immersion substance, and the cover glass approaches zero so that most of the noise from the optical system affecting a view of an image is occupied by the auto-fluorescence component of the specimen holding member. Hence, in this case, when the auto-fluorescence from the specimen holding member is reduced by 10%, it is possible that “the four auto-fluorescence components of the objective lens, the immersion substance, the cover glass, and the specimen holding member are reduced by 10% in total” required to improve the S/N ratio by 5%.

From the above description, the present inventors have studied the S/N ratio of the specimen, the application, or a combination of them and conditions required to improve the S/N ratio, and have completed the present invention. Specifically, the fluorescence observation or fluorescence metering-system of the present invention comprises a low-fluorescence specimen holding member used therein. The low-fluorescence specimen holding member satisfies the following condition:

BSG′/BSG≦0.6 (1-1)

where BSG′ is an average intensity value of auto-fluorescence from the low-fluorescence specimen holding member and BSG is an average intensity value of auto-fluorescence from a conventional specimen holding member generally used.

The upper limit value of Condition (1-1) is derived from the above description that “in order to improve the S/N ratio by 5%, it is necessary to reduce at least one of four auto-fluorescence components of the objective lens, the immersion substance, the cover glass, and the specimen holding member by 40%”.

In the fluorescence observation or the fluorescence metering-system of the present invention, it is more desirable to satisfy the following condition:

BSG′/BSG≦0.45 (1-2)

where BSG′ is an average intensity value of auto-fluorescence from the low-fluorescence specimen holding member and BSG is an average intensity value of auto-fluorescence from a conventional specimen holding member generally used.

Further, in the fluorescence observation or the fluorescence metering-system of the present invention, it is much more desirable to satisfy the following condition:

BSG′/BSG≦0.3 (1-3)

where BSG′ is an average intensity value of auto-fluorescence from the low-fluorescence specimen holding member and BSG is an average intensity value of auto-fluorescence from a conventional specimen holding member generally used.

The fluorescence observation or fluorescence metering-method of the present invention comprises the steps of (A) selecting a specimen emitting fluorescent light that uses a living cell, (B) selecting an application for observing or measuring the specimen selected in step (A) and the fluorescence observation or fluorescence metering-system comprising a low-fluorescence specimen holding member that satisfies the following condition, and (C) making the fluorescence observation or fluorescence measurement of the specimen selected in step (A) by using the application and the system selected in step (B):

BSG′/BSG≦0.6 (1-1)

where BSG′ is an average intensity value of auto-fluorescence from the low-fluorescence specimen holding member and BSG is an average intensity value of auto-fluorescence from a conventional specimen holding member generally used.

The upper limit value of Condition (1-1) is derived from the above description that “in order to improve the S/N ratio by 5%, it is necessary to reduce at least one of four auto-fluorescence components of the objective lens, the immersion substance, the cover glass, and the specimen holding member by 40%”.

In the fluorescence observation or fluorescence metering-method of the present invention, it is more desirable that the low-fluorescence specimen holding member used in step (B) satisfies the following condition:

BSG′/BSG≦0.45 (1-2)

where BSG′ is an average intensity value of auto-fluorescence from the low-fluorescence specimen holding member and BSG is an average intensity value of auto-fluorescence from, a conventional specimen holding member generally used.

Further, in the fluorescence observation or fluorescence metering-method of the pre-sent invention, it is much more desirable that the low-fluorescence specimen holding member used in step (B) satisfies the following condition:

BSG′/BSG≦0.3 (1-3)

where BSG′ is an average intensity value of auto-fluorescence from the low-fluorescence specimen holding member and BSG is an average intensity value of auto-fluorescence from a conventional specimen holding member generally used.

In the fluorescence observation or fluorescence metering-method of the present invention, it is desirable that the specimen emitting the fluorescent light that uses the living cell, selected in step (A), satisfies at least one of the following conditions:

(S−s)/(B+b)≦5 (2-1)

4BSG/B≧0.2 (3-1)

where S is an average intensity value of the fluorescent light emitted from the specimen, s is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.

The upper limit value of Condition (2-1) is made to correspond to the S/N ratio of the application needed for the ease of the fluorescence observation and/or fluorescence measurement of “Specimen with common brightness” in ranking of the brightness of the specimen described above. The lower limit value of Condition (3-1) is made to correspond to Condition (3′-1) of “Common specimen (not cleaned)” in the proportion of the noise of the auto-fluorescence from the optical system to the entire noise mentioned above. Further, the left side of Condition (3-1) is derived from the above description that “of auto-fluorescence constituting the noise of the entire observation optical system (or the measurement optical system), the objective lens accounts for about 20-25%; the immersion substance for about 20-25%; the cover glass for about 20-25%; the specimen holding member for 20-25%; and the objective lens, the immersion substance, the cover glass, and the specimen holding member for about 90% in total” and the proportion of the noise of each of the objective lens, the immersion substance, the cover glass, and the specimen holding member in the entire optical system is the same, and from the fact that the proportion of the noise of the auto-fluorescence from the objective lens, the immersion substance, and the cover glass, of the noise of the auto-fluorescence from the optical system, is replaced with the proportion of the noise of the auto-fluorescence from the specimen holding member, from Condition (3′-1).

In the fluorescence observation or fluorescence metering-method of the present invention, it is desirable that the specimen emitting the fluorescent light that uses the living cell, selected in step (A), satisfies at least one of the following conditions:

(S−s)/(B+b)≦3 (2-2)

4BSG/B≧0.4 (3-2)

where S is an average intensity value of the fluorescent light emitted from the specimen, is a fluctuation range of the intensity of the fluorescent light. B is an average intensity value of a background noise in the absence of the specimen, b is a fluctuation range of the intensity of the background noise, and BSG is an average intensity value of auto-fluorescence from a conventional specimen holding member generally used.

The upper limit value of Condition (2-2) is made to correspond to the S/N ratio of the application needed for the case of the fluorescence observation and/or fluorescence measurement of “dark specimen” in ranking of the brightness of the specimen described above. The lower limit value of Condition (3-2) is made to correspond to Condition (3′-2) of “Cleaned specimen” in the proportion of the noise of the auto-fluorescence from the optical system to the entire noise mentioned above. Further, the left side of Condition (3-2) is derived from the above description that “of auto-fluorescence constituting the noise of the entire observation optical system (or the measurement optical system), the objective lens accounts for about 20-25%; the immersion substance for about 20-25%; the cover glass for about 20-25%; the specimen holding member for 20-25%; and the objective lens, the immersion substance, the cover glass, and the specimen holding member for about 90% in total” and the proportion of the noise of each of the objective lens, the immersion substance, the cover glass, and the specimen holding member in the entire optical system is the same, and from the fact that the proportion of the noise of the auto-fluorescence from the objective lens, the immersion substance, and the cover glass, of the noise of the auto-fluorescence from the optical system, is replaced with the proportion of the noise of the auto-fluorescence from the specimen holding member, from Condition (3′-2).

In the fluorescence observation or fluorescence metering-method of the present invention, it is desirable that the specimen emitting the fluorescent light that uses the living cell, selected in step (A), satisfies at least one of the following conditions:

(S−s)/(B+b)≦2 (2-3)

4BSG/B≧0.6 (3-3)

where S is an average intensity value of the fluorescent light emitted from the specimen, is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.

The upper limit value of Condition (2-3) is made to correspond to the S/N ratio of the application needed for the case of the fluorescence observation and/or fluorescence measurement of “single molecule” in ranking of the brightness of the specimen described above.

The lower limit value of Condition (3-3) is made to correspond to Condition (3′-3) of “Thoroughly cleaned specimen” in the proportion of the noise of the auto-fluorescence from the optical system to the entire noise mentioned above. Further, the left side of Condition (3-3) is derived from the above description that “of auto-fluorescence constituting the noise of the entire observation optical system (or the measurement optical system), the objective lens accounts for about 20-25%; the immersion substance for about 20-25%; the cover glass for about 20-25%; the specimen holding member for 20-25%; and the objective lens, the immersion substance, the cover glass, and the specimen holding member for about 90% in total” and the proportion of the noise of each of the objective lens, the immersion substance, the cover glass, and the specimen holding member in the entire optical system is the same, and from the fact that the proportion of the noise of the auto-fluorescence from the objective lens, the immersion substance, and the cover glass, of the noise of the auto-fluorescence from the optical system, is replaced with the proportion of the noise of the auto-fluorescence from the specimen holding member, from Condition (3′-3).

In the fluorescence observation or fluorescence metering-method of the present invention, it is desirable that the application selected in step (B) is FRET (Fluorescence Resonance Energy Transfer). In the fluorescence observation or fluorescence metering-method of the present invention, it is desirable that the application selected in step (B) is calcium ion imaging. In the fluorescence observation or fluorescence metering-method of the present invention, it is desirable that the application selected in step (B) is a moving-picture observation or time-lapse observation. In the fluorescence observation or fluorescence metering-method of the present invention, it is desirable that the system selected in step (B) is a fluorescence microscope system. Further in the fluorescence observation or fluorescence metering-method of the present invention, it is desirable that the system selected in step (B) is either a reflecting fluorescence system or a transmitting fluorescence system.

In the total reflection illumination fluorescence observation or fluorescence metering-system according to the present invention, a condenser lens is used to provide illumination so that laser light is totally reflected at the bottom of a low-fluorescence specimen holding member and fluorescent light emitted from a specimen held through the specimen holding member by total reflection illumination is detected through an objective lens provided opposite to the condenser lens. The low-fluorescence specimen holding member satisfies the following condition:

BSG′/BSG≦0.89 (1-1′)

where BSG′ is an average intensity value of auto-fluorescence from the low-fluorescence specimen holding member and BSG is an average intensity value of auto-fluorescence from a conventional specimen holding member generally used.

As mentioned above, in the total reflection illumination fluorescence observation or fluorescence metering-system, in which a condenser lens is used to provide illumination so that laser light is totally reflected at the bottom of a low-fluorescence specimen holding member and fluorescent light emitted from a specimen held through the specimen holding member by total reflection illumination is detected through an objective lens provided opposite to the condenser lens, illumination light is incident on the specimen holding member without passing through the objective lens and the cover glass. When the light is totally reflected at the interface between the specimen holding member and the specimen, the specimen is excited by the evanescent wave slightly penetrating into the specimen. In a total reflection microscope observation using such a condenser lens, therefore, fluorescent light emitted fairly close to the specimen is only captured and the auto-fluorescence constituting the noise of each of the objective lens, the immersion substance, and the cover glass approaches zero so that most of the noise from the optical system affecting a view of an image is occupied by the auto-fluorescence component of the specimen holding member.

However, the upper limit value of Condition (1-1′) is derived from the description that “in order to improve the S/N ratio by 5%, it is necessary to reduce the four auto-fluorescence components of the objective lens, the immersion substance, the cover glass, and the specimen holding member by 10% in total” and “in this case, when the auto-fluorescence from the specimen holding member is reduced by 10%, the four auto-fluorescence components of the objective lens, the immersion substance, the cover glass, and the specimen holding member are reduced by 10% in total”.

Subsequently, in accordance with the drawings, the embodiments of the fluorescence observation system, fluorescence metering-system, fluorescence observation method, and fluorescence metering-method will be described in detail.

### Embodiment 1 and Comparative Example 1

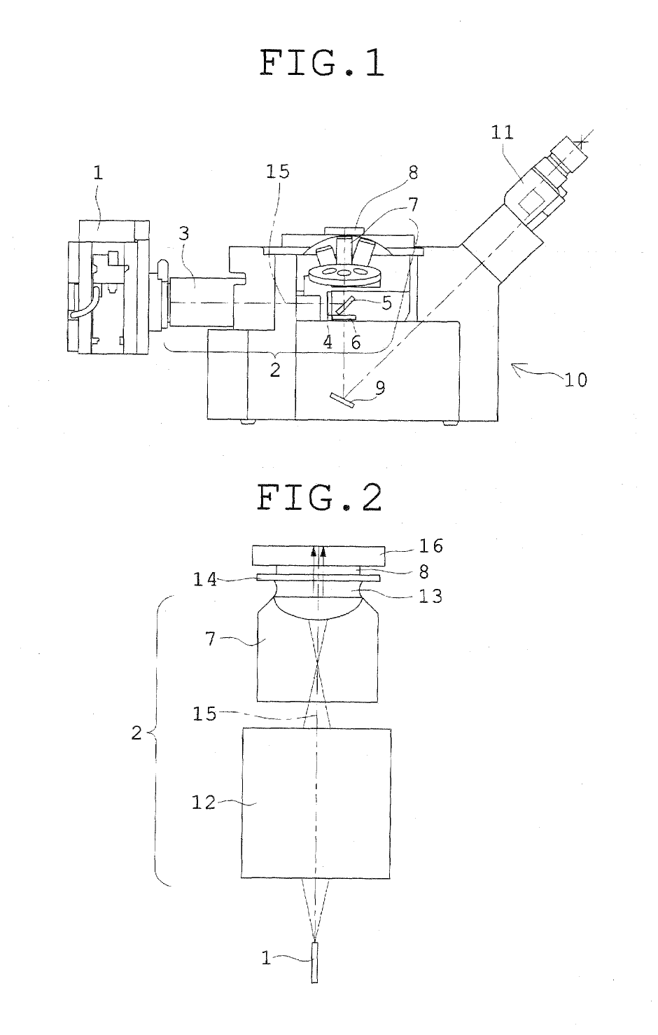

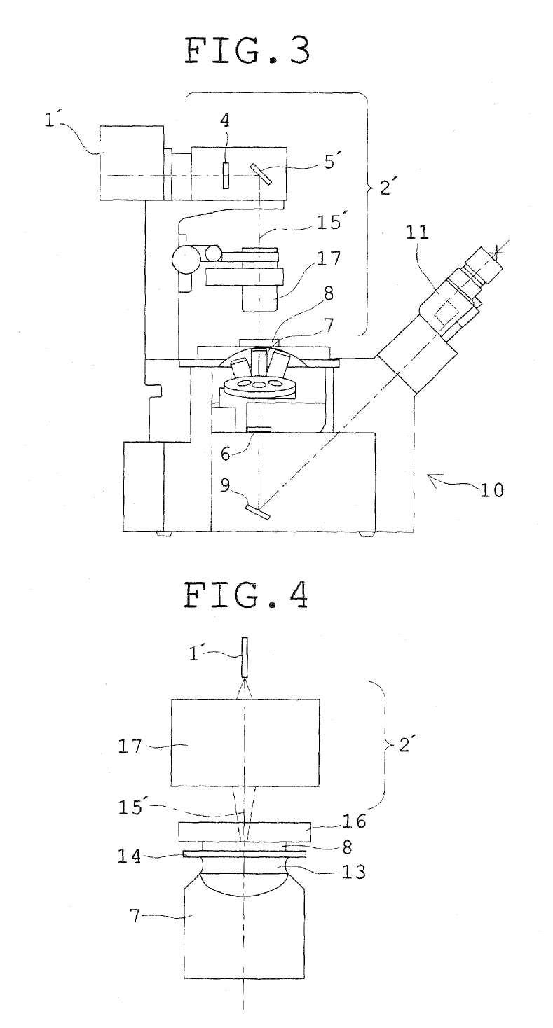

FIG. 1 shows a schematic structure of a reflecting fluorescence microscope apparatus using a white arc light source, as an example of an inverted fluorescence microscope apparatus which is applicable to the fluorescence observation or fluorescence metering-system according to Embodiment 1 and Comparative example 1 of the present invention. FIG. 2 shows a simplified optical arrangement of essential parts in the reflecting fluorescence microscope apparatus of FIG. 1. FIG. 3 shows a schematic structure of a transmitting fluorescence microscope apparatus using a white arc light source, as another example of an inverted fluorescence microscope apparatus which is applicable to the fluorescence observation or fluorescence metering-system according to Embodiment 1 and Comparative example 1 of the present invention. FIG. 4 shows a simplified optical arrangement of essential parts in the transmitting fluorescence microscope apparatus of FIG. 3.

The fluorescence microscope apparatus shown in FIG. 1 is constructed as a microscope comprising a white arc light source 1 and optical members ranging from a reflecting projection tube 3 to an objective lens 7 as an irradiation optical system 2 irradiating a specimen (a sample) 8 with light emitted from the white arc light source 1. In FIG. 1, reference numeral 5 denotes a dichroic mirror; 4, an absorption filter; 6, a barrier filter; 9, a mirror; 10, a microscope body; and 11, an observation lens barrel.

The irradiation optical system 2, as shown in FIG. 2, has the objective lens 7 placed on the specimen-8 side and a collector lens 12 placed in the reflecting projection tube (omitted from the figure). In FIG. 2, reference numeral 13 represents an immersion substance; 14, a cover glass; 15, an optical axis; and 16, a slide glass as the specimen holding member. In FIG. 2, for convenience, the absorption filter 4 and the dichroic mirror 5 are eliminated and the members ranging from the white arc light source 1 to the objective lens 7 are linearly shown. The collector lens 12 is constructed to collect the light emitted from the white arc light source 1 at or in the proximity of the back focal position of the objective lens 7. The specimen 8 is sandwiched between the slide glass 16 and the cover glass 14. A space between the objective lens 7 and the cover glass 14 is filled with the immersion substance 13. Also, fluorescent light emitted from the specimen 8 is observed through the objective lens 7, the dichroic mirror 5, the barrier filter 6, the mirror 9 and the observation lens barrel 11. The microscope of FIG. 1 is such that a detector (not shown) is mounted at a preset position conjugate with an observation position and the intensity of the fluorescent light can be detected through the detector.

The fluorescence microscope apparatus shown in FIG. 3 is constructed as a microscope comprising a white arc light source 1′ and optical members including a condenser lens 17 as an irradiation optical system 2′ irradiating the specimen (the sample) 8 with light emitted from the white arc light source 1′. In FIG. 3, reference numeral 5′ denotes a mirror; 4, the absorption filter; 6, the barrier filter; 7, the objective lens; 9, the mirror; 10, the microscope body; and 11, the observation lens barrel. The irradiation optical system 2′, as shown in FIG. 4, has the condenser lens 17 placed on the opposite side of the objective lens 7 with respect to the specimen 8. In FIG. 4, reference numeral 13 represents the immersion substance; 14, the cover glass; 15′, an optical axis; and 16, the slide glass as the specimen holding member. In FIG. 4, for convenience, the absorption filter 4 and the mirror 5′ are eliminated and the members ranging from the white arc light source 1′ to the objective lens 7 are linearly shown.

The specimen 8 is sandwiched between the slide glass 16 and the cover glass 14. A space between the objective lens 7 and the cover glass 14 is filled with the immersion substance 13. Also, fluorescent light emitted from the specimen 8 is observed through the objective lens 7, the barrier filter 6, the mirror 9, and the observation lens barrel 11. The microscope of FIG. 3 is such that a detector (not shown) is mounted at a preset position conjugate with an observation position and the intensity of the fluorescent light can be detected through the detector.

Subsequently, a description is given of fluorescence microscope apparatuses of Embodiment 1 and Comparative example 1. The fundamental optical arrangements of the fluorescence microscope apparatuses of Embodiment 1 and Comparative example 1 are the same as those of the fluorescence microscope apparatuses shown in FIGS. 1 and 2 and FIGS. 3 and 4. In the following, only different components between the embodiment and the comparative example are described to avoid the duplication of explanation of identical components.

Measurement of the Amount of Auto-Fluorescence from Specimen Holding Member

The microscope apparatus identical in fundamental optical arrangement with the fluorescence microscope apparatus shown in FIG. 1 is used to make the measurement of the amount of auto-fluorescence from the specimen holding member of each of Embodiment 1 and Comparative example 1. For the objective lens 7. Model UPLFLN 40X made by OLYMPUS CORP. is used. As the detector omitted from the figure, a photomultiplier tube (R6355) made by Hamamatsu Photonics K. K. is used.

The specimen holding member itself is placed on a stage so that the objective lens touches on the specimen holding member, in this state, the member is irradiated with excitation light of wavelength 488 nm and a numerical value (here, assumed as a numerical value A) detected by the detector is counted. Next, the specimen holding member is removed from the stage and the member is irradiated with the excitation light of wavelength 488 nm in a state where the objective lens is about 1 mm away from the stage so that a numerical value (here, assumed as a numerical value B) detected by the detector is counted. By subtracting the numerical value B from the numerical value A, the amount of auto-fluorescence from the specimen holding member is obtained.

### Comparative Example 1

The microscope apparatus identical in fundamental optical arrangement with the fluorescence microscope apparatuses shown in FIGS. 1 and 2 and FIGS. 3 and 4 is used to carry out the fluorescence observation and the intensity of auto-fluorescence in this case is measured.

For the slide glass 16 as the specimen holding member, a slide glass for fluorescence microscopes. NEO No. 1, made by MATSUNAMI GLASS IND., LTD. is used. Model UPLSAPO 60XO made by OLYMPUS CORP. is used for the objective lens 7, MICROCOVER GLASS No. 1-S made by MATSUNAMI GLASS IND., LTD. for the cover glass 14, and the immersion oil (nd= 1.52) prepared by OLYMPUS CORP. for the immersion substance 13. Further, Model 1X71 made by OLYMPUS CORP. Is used for the body 10 of the inverted microscope. As the detector omitted from the figure, Model EM-CCD made by Hamamatsu Photonics K. K. is used and the fluorescence observation under an ordinary reflecting fluorescence system such as that shown in FIGS. 1 and 2 and a transmission fluorescence observation shown in FIGS. 3 and 4 are carried out to measure the intensity of auto-fluorescence. The fluorescence observation specimen in this case satisfies Condition (2-1) (namely, (S−s)/(B+b)≦5) and Condition (3-1) (namely, 4 BSG/B≧0.2).

In the fluorescence microscope apparatus of Comparative example 1, the background noise due to the auto-fluorescence is large and thus the fluorescence observation cannot be satisfactorily carried out.

### Embodiment 1

The microscope apparatus identical in fundamental optical arrangement with the fluorescence microscope apparatuses of Comparative example 1 is used to carry out the fluorescence observation and the intensity of auto-fluorescence in this case is measured.

In the fluorescence microscope apparatus of Embodiment 1, only the specimen holding member 16 (the slide glass), of optical members used in the fluorescence microscope apparatus of Comparative example 1, is changed to the low-fluorescence specimen holding member 16 and the others are the same in structure as in Comparative example 1. For the low-fluorescence specimen holding member 16 of Embodiment 1, the slide glass is used in which Super Clear made by Nippon Sheet Glass Co. Ltd. is cut into the same size (26 mm×76 mm, 1 mm thick) as the slide glass for fluorescence microscopes, NEO No. 1, made by MATSUNAMI GLASS IND. LTD. and its surface is ground.

Also, when amounts of auto-fluorescence from the specimen holding members used in Comparative example 1 and Embodiment 1 are measured, the amount in Embodiment 1 is 0.25 where the amount in Comparative example 1 is assumed as 1. Specifically, the ratio of the intensity of the auto-fluorescence from the specimen holding member 16 of Embodiment 1 to the intensity of the auto-fluorescence from the specimen holding member 16 of Comparative example 1 satisfies Condition (1-1) (namely, BSG′/BSG≦0.6). When the low-fluorescence specimen holding member (the slide glass) of Embodiment 1 is used and the same specimen as in the fluorescence observation under the ordinary reflecting fluorescence system according to the fluorescence microscope of Comparative example 1 is observed on the same condition, the background noise due to the auto-fluorescence is lessened and the S/N ratio of a fluorescent image is improved, with the result that it has become possible to satisfactorily carry out the fluorescence observation.

By the comparison of Comparative example 1 with Embodiment 1, it has been confirmed that when the specimen holding member (the slide glass) of the present invention is used, the S/N ratio of the fluorescence observation image is improved and an high-quality observation is possible.

Also, the present invention is not limited to the ratio with the intensity of the auto-fluorescence from the specimen holding member in the fluorescence microscope apparatus of embodiment 1. For example, in Embodiment 1, when the specimen holding member satisfying the condition, preferably BSG′/BSG≦0.45, and more preferably BSG′/BSG≦0.3, is used, the S/N ratio is further improved.

In the fluorescence observation using the specimen holding member of Embodiment 1, instead of a combination of Condition (2-1) (namely, (S−s)/(B+b)≦5) with Condition (3-1) (namely, 4 BSG/B≧0.2) as the fluorescence observation specimen, the following combinations of conditions have also found to bring about the improvement of the S/N ratio of the fluorescence observation image and the result of a high-quality observation:

a combination of Condition (2-2) (namely, (S−s)/(B+b)≦3) with Condition (3-2) (namely, 4 BSG/B≧0.4), and

a combination of Condition (2-3) (namely, (S−s)/(B+b)≦2) with Condition (3-3) (namely, 4 BSG/B≧0.6)

Also, although reference has been made to the inverted microscope in Embodiment 1, the present invention is not limited or applied to the inverted microscope and the same effect is brought about in the upright microscope.

The microscope applying the present invention is constructed as an upper-and-lower microscope in which the inverted microscope and the upright microscope are arranged with the specimen between them. In the case of the upper-and-lower microscope, when the specimen holding member shown in the embodiment of the present invention is used on either the upright microscope side or the inverted microscope side, the effect of the present invention is brought about. In the upper-and-lower microscope, the upright microscope side and the inverted microscope side may be constructed so that each of them is driven independently or both are driven in association with each other. In addition, observation techniques different from each other in the upper-and-lower microscope may be used in such a way that the ordinary fluorescence observation is carried out on the upright microscope side, while the total reflection fluorescence observation is carried out on the inverted microscope side.

### Embodiment 2 and Comparative Example 2

Subsequently, a description is given of a total internal reflection fluorescence observation (TIRF observation) system of a condenser lens mode as Embodiment 2 and Comparative example 2 of the present invention.

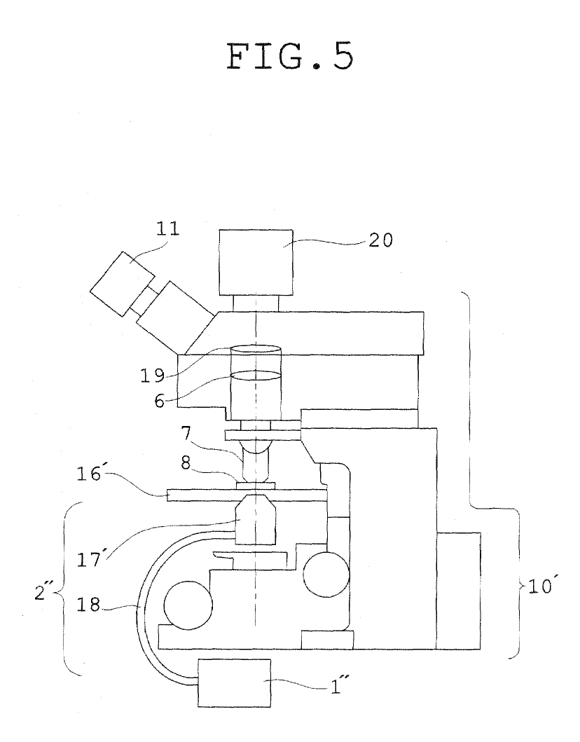

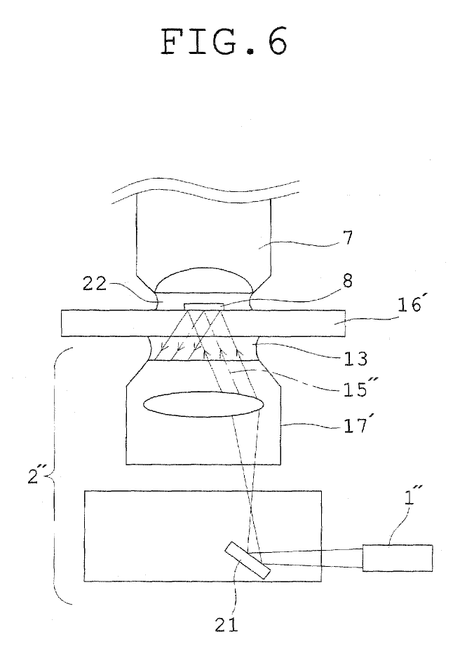

FIG. 5 shows a schematic structure of a total reflecting fluorescence microscope apparatus of a condenser lens mode using a laser light source, as an example of an upright fluorescence microscope apparatus which is applicable to the fluorescence observation or fluorescence metering-system according to Embodiment 2 and Comparative example 2 of the present invention, and FIG. 6 shows a simplified optical arrangement of essential parts in the total reflecting fluorescence microscope apparatus of FIG. 5.

In the total reflection fluorescence observation apparatus of the condenser lens mode shown in FIG. 5, a vessel (a petri dish, dish, slide glass, etc.) capable of reserving a liquid, such as a culture medium, is used as a specimen holding member 16′ (Also, for convenience, FIGS. 5 and 6 depict only a holding portion close to the specimen 8 with respect to the specimen holding member 16′). This microscope apparatus is constructed as a microscope which includes a laser light source 1″ and optical members ranging from an optical fiber 18 to a condenser lens 17′ as an irradiation optical system 2″ irradiating the specimen (sample) 8, through total reflection, with light emitted from the laser light source 1″. The laser light source 1″ is connected by the optical fiber 18 with the condenser lens 17′. In order to provide total reflection illumination through the condenser lens 17′, the irradiation optical system 2″ is provided with a mechanism which allows the position of incidence of a laser spot on the condenser lens 17′ to be adjusted (a mirror 21 shown in FIG. 6 which allows the incidence angle to be adjusted). In FIG. 5, reference numeral 7 denotes the objective lens; 6, the barrier filter; 10′, a microscope body; 19, an imaging lens; and 20, a detector. Also, in FIG. 6, the optical fiber 18 shown in FIG. 5 is omitted for convenience. As for the rest, the irradiation optical system 2″ has an absorption filter, although omitted from the figure, transmitting an excitation wavelength only, of the light emitted from the laser light source 1″, and absorbing remaining wavelengths. In addition, the microscope shown in FIG. 5 is provided with a path splitting member (omitted from the figure) in which fluorescent light passing through the barrier filter 6 can be introduced into both the observation lens barrel 11 and the detector 20.

In the total reflection illumination illustrated in FIG. 6, illumination light introduced through the optical fiber 18 of FIG. 5 is incident from the periphery of the condenser lens 17′ on the immersion substance 13 and the specimen holding member 16′ at a large incidence angle (for undergoing the total reflection at the interface with the specimen 8) and is totally reflected at the interface between the specimen holding member 16′ and the specimen 8. In this case, the evanescent wave slightly penetrating from the specimen holding member 16′ into the specimen 8 changes to excitation light relative to the specimen 8. In FIG. 6, reference numeral 15″ represents an optical axis and 22 represents water with which a space between the objective lens 7 and the specimen 8 is charged.

In the total reflection illumination of the condenser lens mode, illumination light is incident on the specimen holding member without passing through the objective lens and the cover glass (Also, in the microscope system, of FIG. 6, the cover glass is not originally used). In the total reflection illumination of the condenser lens mode shown in FIG. 6, therefore, fluorescent light emitted fairly close to the specimen 8 is only captured and auto-fluorescence produced from the immersion substance 13 and the objective lens 7 is not entirely detected. Consequently, only auto-fluorescence form the specimen holding member 16′, closest to the specimen 8, can be thought of as a noise source from an optical system affecting the view of an image. Also, fluorescent light emitted from the specimen 8 is observed through the objective lens 7, the dichroic mirror 5, the barrier filter 6, the imaging lens 19, the path splitting member (not shown), and the observation lens barrel 11. The fluorescent light passing through the imaging lens 19 is such that its intensity is detected through the imaging lens 19, the path splitting member (not shown), and the detector 20.

### Comparative Example 2

The total reflecting fluorescence microscope apparatus of the condenser lens mode identical in fundamental optical arrangement with the total reflecting fluorescence microscope apparatus of the condenser lens mode shown in FIGS. 5 and 6 is used to carry out the total reflection fluorescence observation and the intensity of auto-fluorescence in this case is measured. For the specimen holding member 16′, a slide glass for fluorescence microscopes, NEO No. 1, made by MATSUNAMI GLASS IND. LTD. is used. Model XLUMP1anF120XW made by OLYMPUS CORP. is used for the objective lens 7, an Ar laser (λ= 488 nm) for the light source 1″, a 488 band-pass filter for the absorption filter, a 550 high-pass filter for the barrier filter 6. Model WI-CDEVA made by OLYMPUS CORP. for the condenser lens 17′, Model U-TLU made by OLYMPUS CORP. for the imaging lens 19, and the immersion oil prepared by OLYMPUS CORP. for the immersion substance 13. For the body 10′ of the upright microscope. Model BX51WI made by OLYMPUS CORP. is used. Model EM-CCD made by Hamamatsu Photonics K. K. is used for the detector 20 and the single-molecule fluorescence observation is carried out by the total reflection illumination shown in FIGS. 5 and 6 to measure the intensity of auto-fluorescence.

The fluorescence observation specimen in this case is such that the dye Alexa 488-IGG, after being adjusted to 1 nM or less, is applied on the specimen holding member 16′. This specimen satisfies Condition (2-3) (namely, (S−s)/(B+b)≦2) and Condition (3-3) (namely, 4 BSG/B≧0.6).

In the total reflecting fluorescence microscope apparatus of the condenser lens mode of Comparative example 2, the background noise due to the auto-fluorescence is large and thus the fluorescence observation cannot be satisfactorily carried out.

### Embodiment 2

The total reflecting fluorescence microscope apparatus of the condenser lens mode identical in fundamental optical arrangement with the total reflecting fluorescence microscope apparatuses of the condenser lens mode of Comparative example 2 is used to carry out the single-molecule fluorescence observation with the total reflection illumination and the intensity of auto-fluorescence in this case is measured. In the total reflecting fluorescence microscope apparatus of the condenser lens mode of Embodiment 2, only the specimen holding member 16′, of optical members used in the total reflecting fluorescence microscope apparatus of the condenser lens mode of Comparative example 2, is changed to the low-fluorescence specimen holding member 16′ and the others are the same in structure as in Comparative example 2. For the low-fluorescence specimen holding member 16′ of Embodiment 2, the same member as the low-fluorescence specimen holding member 16 used in Embodiment 1 is used. The ratio of the intensity of the auto-fluorescence from the specimen holding member 16′ of Embodiment 2 to the intensity of the auto-fluorescence from the specimen holding member 16′ of Comparative example 2 satisfies Condition (1-1′) (namely; BSC/BSG≦0.89).

When the low-fluorescence specimen holding member of Embodiment 2 is used and the same specimen as in the single-molecule fluorescence observation with the total reflection illumination according to the total reflecting fluorescence microscope apparatus of the condenser lens mode of Comparative example 2 is prepared and observed on the same condition, it has been able to confirm that the background noise due to the auto-fluorescence is lessened and the S/N ratio of a fluorescence observation image is improved. By the comparison of Comparative example 2 with Embodiment 2, it has been able to confirm that the specimen holding member of the present invention is used, and thereby the S/N ratio of the fluorescence observation image is improved and an higher-quality observation is possible.

As will be understood from the above description, the fluorescence observation or fluorescence metering-system and the fluorescence observation or fluorescence metering-method of the present invention. In addition to claims to be described later, have features listed below.

(1) The fluorescence observation or fluorescence metering-system comprises a low-fluorescence specimen holding member. The low-fluorescence specimen holding member satisfies the following condition:

BSG′/BSG≦0.45 (1-2)

where BSG′ is an average intensity value of auto-fluorescence from the low-fluorescence specimen holding member and BSG is an average intensity value of auto-fluorescence from a conventional specimen holding member generally used.
(2) The fluorescence observation or fluorescence metering-system comprises a low-fluorescence specimen holding member. The low-fluorescence specimen holding member satisfies the following condition:

BSG′/BSG≦0.3 (1-3)

where BSG′ is an average intensity value of auto-fluorescence from the low-fluorescence specimen holding member and BSG is an average intensity value of auto-fluorescence from a conventional specimen holding member generally used.
(3) In the fluorescence observation or fluorescence metering-method of claim 2, the specimen emitting fluorescent light that uses a living cell, selected in step (A) satisfies at least one of the following conditions:

(S−s)/(B+b)≦3 (2-2)

4BSG/B≧0.4 (3-2)

where S is an average intensity value of the fluorescent light emitted from the specimen, is a fluctuation range of the intensity of the fluorescent light. B is an average intensity value of a background noise in the absence of the specimen, b is a fluctuation range of the intensity of the background noise, and BSG is an average intensity value of auto-fluorescence from a conventional specimen holding member generally used.
(4) In the fluorescence observation or fluorescence metering-method of Item (3), the application selected in step (B) is FRET (Fluorescence Resonance Energy Transfer).
(5) In the fluorescence observation or fluorescence metering-method of item (4), the system selected in step (B) is a fluorescence microscope system.
(6) In the fluorescence observation or fluorescence metering-method of item (3), the application selected in step (B) is calcium ion imaging.
(7) In the fluorescence observation or fluorescence metering-method of item (6), the system selected in step (B) is a fluorescence microscope system.
(8) In the fluorescence observation or fluorescence metering-method of item (3), the application selected in step (B) is a moving-picture observation or time-lapse observation.
(9) In the fluorescence observation or fluorescence metering-method of item (8), the system selected in step (B) is a fluorescence microscope system.
(10) In the fluorescence observation or fluorescence metering-method of claim 2, the specimen emitting fluorescent light that uses a living cell, selected in step (A) satisfies at least one of the following conditions:

(S−s)/(B+b)≦2 (2-3)

4BSG/B≧0.6 (3-3)

where S is an average intensity value of the fluorescent light limited from the specimen, is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.
(11) In the fluorescence observation or fluorescence metering-method of item (10), the application selected in step (B) is FRET (Fluorescence Resonance Energy Transfer).
(12) In the fluorescence observation or fluorescence metering-method of item (11), the system selected in step (B) is a fluorescence microscope system.
(13) In the fluorescence observation or fluorescence metering-method of item (10), the application selected in step (B) is calcium ion imaging.
(14) In the fluorescence observation or fluorescence metering-method of item (13), the system selected in step (B) is a fluorescence microscope system.
(15) In the fluorescence observation or fluorescence metering-method of item (10), the application selected in step (B) is a moving-picture observation or time-lapse observation.
(16) In the fluorescence observation or fluorescence metering-method of item (15), the system selected in step (B) is a fluorescence microscope system.
(17) The fluorescence observation or fluorescence metering-method comprises the steps of (A) selecting a specimen emitting fluorescent light that uses a living cell, (B) selecting an application for observing or measuring the specimen selected in step (A) and the fluorescence observation or fluorescence metering-system comprising a low-fluorescence specimen holding member that satisfies the following condition, and (C) making the fluorescence observation or fluorescence measurement of the specimen selected in step (A) by using the application and the system selected in step (B):

BSG′/BSG≦0.45 (1-2)

where BSG′ is an average intensity value of auto-fluorescence from, the low-fluorescence specimen holding member and BSG is an average intensity value of auto-fluorescence from a conventional specimen holding member generally used.
(18) In the fluorescence observation or fluorescence metering-method of item (17), the specimen emitting fluorescent light that uses a living cell, selected in step (A) satisfies at least one of the following conditions:

(S−s)/(B+b)≦5 (2-1)

4BSG/B≧0.2 (3-1)

where S is an average intensity value of the fluorescent light emitted from the specimen, is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.
(19) In the fluorescence observation or fluorescence metering-method of item (18), the application selected in step (B) is FRET (Fluorescence Resonance Energy Transfer).
(20) In the fluorescence observation or fluorescence metering-method of item (19), the system selected in step (B) is a fluorescence microscope system.
(21) in the fluorescence observation or fluorescence metering-method of item (18), the application selected in step (B) is calcium ion imaging.
(22) In the fluorescence observation or fluorescence metering-method of item (21), the system selected in step (B) is a fluorescence microscope system.
(23) In the fluorescence observation or fluorescence metering-method of item (18), the application selected in step (B) is a moving-picture observation or time-lapse observation.
(24) In the fluorescence observation or fluorescence metering-method of item (23), the system selected in step (B) is a fluorescence microscope system.
(25) In the fluorescence observation or fluorescence metering-method of item (17), the specimen emitting fluorescent light that uses a living cell, selected in step (A) satisfies at least one of the following conditions:

(S−s)/(B+b)≦3 (2-2)

4BSG/B≧0.4 (3-2)

where S is an average intensity value of the fluorescent light emitted from the specimen, is a fluctuation range of the intensity of the fluorescent light. B is an average intensity value of a background noise in the absence of the specimen, b is a fluctuation range of the intensity of the background noise, and BSG is an average intensity value of auto-fluorescence from a conventional specimen holding member generally used.
(26) In the fluorescence observation or fluorescence metering-method of item (25), the application selected in step (B) is FRET (Fluorescence Resonance Energy Transfer).
(27) In the fluorescence observation or fluorescence metering-method of item (26), the system selected in step (B) is a fluorescence microscope system.
(28) In the fluorescence observation or fluorescence metering-method of item (25), the application selected in step (B) is calcium ion imaging.
(29) In the fluorescence observation or fluorescence metering-method of item (28), the system selected in step (B) is a fluorescence microscope system.
(30) In the fluorescence observation or fluorescence metering-method of item (25), the application selected in step (B) is a moving-picture observation or time-lapse observation.
(31) In the fluorescence observation or fluorescence metering-method of item (30), the system selected in step (B) is a fluorescence microscope system.
(32) In the fluorescence observation or fluorescence metering-method of item (17), the specimen emitting fluorescent light that uses a living cell, selected in step (A) satisfies at least one of the following conditions:

(S−s)/(B+b)≦2 (2-3)

4BSG/B≧0.6 (3-3)

where S is an average intensity value of the fluorescent light emitted from the specimen, is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.
(33) In the fluorescence observation or fluorescence metering-method of item (32), the application selected in step (B) is FRET (Fluorescence Resonance Energy Transfer).
(34) In the fluorescence observation or fluorescence metering-method of item (33), the system selected in step (B) is a fluorescence microscope system.
(35) In the fluorescence observation or fluorescence metering-method of item (32), the application selected in step (B) is calcium ion imaging.
(36) In the fluorescence observation or fluorescence metering-method of item (35), the system selected in step (B) is a fluorescence microscope system.
(37) In the fluorescence observation or fluorescence metering-method of item (32), the application selected in step (B) is a moving-picture observation or time-lapse observation.
(38) In the fluorescence observation or fluorescence metering-method of item (37), the system selected in step (B) is a fluorescence microscope system.
(39) The fluorescence observation or fluorescence metering-method comprises the steps of (A) selecting a specimen emitting fluorescent light that uses a living cell, (B) selecting an application for observing or measuring the specimen selected in step (A) and the fluorescence observation or fluorescence metering-system comprising a low-fluorescence specimen holding member that satisfies the following condition, and (C) making the fluorescence observation or fluorescence measurement of the specimen selected in step (A) by using the application and the system selected in step (B):

BSG′/BSG≦0.3 (1-3)

where BSG′ is an average intensity value of auto-fluorescence from the low-fluorescence specimen holding member and BSG is an average intensity value of auto-fluorescence from a conventional specimen holding member generally used.
(40) In the fluorescence observation or fluorescence metering-method of item (39), the specimen emitting fluorescent light that uses a living cell, selected in step (A) satisfies at least one of the following conditions:

(S−s)/(B+b)≦5 (2-1)

4BSG/B≧0.2 (3-1)

where S is an average intensity value of the fluorescent light emitted from the specimen, is a fluctuation range of the intensity of the fluorescent light. B is an average intensity value of a background noise in the absence of the specimen, b is a fluctuation range of the intensity of the background noise, and BSG is an average intensity value of auto-fluorescence from a conventional specimen holding member generally used.
(41) In the fluorescence observation or fluorescence metering-method of item (40), the application selected in step (B) is FRET (Fluorescence Resonance Energy Transfer).
(42) In the fluorescence observation or fluorescence metering-method of item (41), the system selected in step (B) is a fluorescence microscope system.
(43) In the fluorescence observation or fluorescence metering-method of item (40), the application selected in step (B) is calcium ion imaging.
(44) In the fluorescence observation or fluorescence metering-method of item (43), the system selected in step (B) is a fluorescence microscope system.
(45) In the fluorescence observation or fluorescence metering-method of item (40), the application selected in step (B) is a moving-picture observation or time-lapse observation.
(46) In the fluorescence observation or fluorescence metering-method of item (45), the system selected in step (B) is a fluorescence microscope system.
(47) In the fluorescence observation or fluorescence metering-method of item (39), the specimen emitting fluorescent light that uses a living cell, selected in step (A) satisfies at least one of the following conditions:

(S−s)/(B+b)≦3 (2-2)

4BSG/B≧0.4 (3-2)

where S is an average intensity value of the fluorescent light emitted from the specimen, is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.
(48) In the fluorescence observation or fluorescence metering-method of item (47), the application selected in step (B) is FRET (Fluorescence Resonance Energy Transfer).
(49) In the fluorescence observation or fluorescence metering-method of item (48), the system selected in step (B) is a fluorescence microscope system.
(50) In the fluorescence observation or fluorescence metering-method of item (47), the application selected in step (B) is calcium ion imaging.
(51) In the fluorescence observation or fluorescence metering-method of item (50), the system selected in step (B) is a fluorescence microscope system.
(52) In the fluorescence observation or fluorescence metering-method of item (47), the application selected in step (B) is a moving-picture observation or time-lapse observation.
(53) In the fluorescence observation or fluorescence metering-method of item (52), the system selected in step (B) is a fluorescence microscope system.
(54) In the fluorescence observation or fluorescence metering-method of item (39), the specimen emitting fluorescent light that uses a living cell, selected in step (A) satisfies at least one of the following conditions:

(S−s)/(B+b)≦2 (2-3)

4BSG/B≧0.6 (3-3)

where S is an average intensity value of the fluorescent light emitted from the specimen, is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.
(55) In the fluorescence observation or fluorescence metering-method of item (54), the application selected in step (B) is FRET (Fluorescence Resonance Energy Transfer).
(56) In the fluorescence observation or fluorescence metering-method of item (55), the system selected in step (B) is a fluorescence microscope system.
(57) In the fluorescence observation or fluorescence metering-method of item (54), the application selected in step (B) is calcium ion imaging.
(58) In the fluorescence observation or fluorescence metering-method of item (57), the system selected in step (B) is a fluorescence microscope system.
(59) In the fluorescence observation or fluorescence metering-method of item (54), the application selected in step (B) is a moving-picture observation or time-lapse observation.
(60) In the fluorescence observation or fluorescence metering-method of item (59), the system selected in step (B) is a fluorescence microscope system.

The fluorescence observation or fluorescence metering-system and the fluorescence observation or fluorescence metering-method of the present invention are useful in the fields of microscopes, fluorescence microscopes, and protein and/or DNA analytical apparatuses in which accurate quantification including the noise is required with respect to the technique which allows ace male observation and/or measurement of feeble fluorescent light in a broad band.

What is claimed is:

1. A fluorescence observation or fluorescence metering-system comprising a low-fluorescence specimen holding member used therein, the low-fluorescence specimen holding member satisfying the following condition:
BSG′/BSG≦0.6
where BSG′ is an average intensity value of auto-fluorescence from the low-fluorescence specimen holding member and BSG is an average intensity value of auto-fluorescence from a conventional specimen holding member generally used.

2. A fluorescence observation or fluorescence metering-method comprising the steps of:
(A) selecting a specimen emitting fluorescent light that uses a Jiving cell;
(B) selecting an application for observing or measuring the specimen selected in step (A) and a fluorescence observation or fluorescence metering-system comprising a low-fluorescence specimen holding member which satisfies the following condition; and
(C) making a fluorescence observation or fluorescence measurement of the specimen selected in step (A) by using the application and the system selected in step (B):
BSG′/BSG≦0.6
where BSG′ is an average intensity value of auto-fluorescence from the low-fluorescence specimen holding member and BSG is an average intensity value of auto-fluorescence from a conventional specimen holding member generally used.

3. A fluorescence observation or fluorescence metering-method according to claim 2, wherein the specimen emitting the fluorescent light that uses the living cell, selected in step (A), satisfies at least one of the following conditions:
(S−s)/(B+b)≦5
4BSG/B≧0.2
where S is an average intensity value of the fluorescent light emitted from the specimen, s is a fluctuation range of the intensity of the fluorescent light, B is an average intensity value of a background noise in the absence of the specimen, b is a fluctuation range of the intensity of the background noise, and BSG is an average intensity value of auto-fluorescence from a conventional specimen holding member generally used.

4. A fluorescence observation or fluorescence metering-method according to claim 3, wherein the application selected in step (B) is FRET (Fluorescence Resonance Energy Transfer).

5. A fluorescence observation or fluorescence metering-method according to claim 4, wherein the system selected in step (B) is a fluorescence microscope system.

6. A fluorescence observation or fluorescence metering-method according to claim 3, wherein the application selected in step (B) is calcium ion imaging.

7. A fluorescence observation or fluorescence metering-method according to claim 6, wherein the system selected in step (B) is a fluorescence microscope system.

8. A fluorescence observation or fluorescence metering-method according to claim 4, wherein the system selected in step (B) is a reflecting fluorescence system or transmitting fluorescence system.

9. A fluorescence observation or fluorescence metering-method according to claim 3, wherein the application selected in step (B) is a moving-picture observation or time-lapse observation.

10. A fluorescence observation or fluorescence metering-method according to claim 9, wherein the system selected in step (B) is a fluorescence microscope system.

11. A total reflection illumination fluorescence observation or fluorescence metering-system in which a condenser lens is used to provide illumination so that laser light is totally reflected at a bottom of a low-fluorescence specimen holding member and fluorescent light emitted from a specimen held through the specimen holding member by total reflection illumination is detected through an objective lens provided opposite to the condenser lens, the low-fluorescence specimen holding member satisfying the following condition:
BSG′/BSG≦0.89
where BSG′ is an average intensity value of auto-fluorescence from the low-fluorescence specimen holding member and BSG is an average intensity value of auto-fluorescence from a conventional specimen holding member generally used.

12. A fluorescence observation or fluorescence metering-system according to claim 1 or 11, wherein the low-fluorescence specimen holding member is a glass petri dish or glass-bottomed dish.

13. A fluorescence observation or fluorescence metering-system according to claim 1 or 11, wherein the low-fluorescence specimen holding member is a slide glass.
